(19) United States
(12) Patent Application Publication
(10) Pub. No.: US 2008/0245623 A1
(43) Pub. Date: Oct. 9, 2008

(54) Brake Housing

(75) Inventor: Stan Nowak, Canning Vale (AU)

Correspondence Address: SEED INTELLECTUAL PROPERTY LAW GROUP PLLC, 701 FIFTH AVE, SUITE 5400, SEATTLE, WA, 98104, US

(73) Assignee: ADVANCED BRAKING TECHNOLOGY LTD, OSBORNE PARK (AU)

(21) Appl. No.: 11/884,859

(22) PCT Filed: Feb. 21, 2006
(86) PCT No.: PCT/AU2006/000218

§ 371 Date: Jun. 2, 2008

(30) Foreign Application Priority Data
Feb. 21, 2005 (AU) 2005900781

(51) Int. Cl. F16D 55/226

(52) U.S. Cl. 188/73.31

(57) ABSTRACT

The brake housing (12) comprises a first portion (14), a second portion (16), and a demountably coupled cylinder block (18). The first and second portions (14, 16) comprise respective openings (40, 68) through which a rotating component passes. The portions (14) and (16) are coupled together to define an internal space about a portion of the rotating body. One or more cylinder blocks (18) are formed separately of the first and second portions (14, 16) and directly demountably coupled to the first or second portions. Each cylinder block (18) is provided with a first surface (28) that faces the portion (14, 16) to which the cylinder block is coupled. Each block (18) is also provided with one or more cavities (20) that open onto an opposite surface (22) of the cylinder blocks (18) for receiving respective pistons (24). The blocks (18) can be fixed at any location inside the housing (12) to meet the requirements of the associated brake assembly at hand.

### FIELD OF THE INVENTION

The present invention relates to a brake housing.

### BACKGROUND OF THE INVENTION

Brake housings are often provided for disc brake systems particularly in large or heavy vehicles to provide protection to major components of the disc brake system from foreign objects and particles. Such housings are also provided for wet disc brake systems for the purposes of containment of a lubricant through which an associate rotor rotates.

The brake housings typically comprise a first portion having a drum like structure similar to the drum of a drum brake, and a second portion in the form of a plate that is fastened to the first portion to define a space therebetween in which the major components of the disc brake such as the rotor, pads, cylinders and pistons reside. The cylinders are formed integrally with the first portion and are provided with cavities for seating corresponding pistons. While the dimensions of the first and second portions are often uniform for brakes of different models of vehicles made by the same manufacturer, and indeed from manufacturer to manufacturer, the configuration and placement of the cylinders and pistons is often unique for each model of vehicle and for each manufacturer. Therefore the manufacturing process requires the production of different moulds for the casting of the first portions for different vehicle models and manufacturers; and, spare parts retailers are required to carry large inventories to ensure supply of differently configured first portions of the brake housings.

It is to be understood that, if any prior art publication is referred to herein, such reference does not constitute an admission that the publication forms a part of the common general knowledge in the art, in Australia or any other country.

Throughout this specification except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

### SUMMARY OF THE INVENTION

According to the present invention there is provided a brake housing comprising:
separate first and second portions, each portion having an opening through which a rotating body passes, the first and second portions coupled together to define an internal space about a portion of the rotating body; and,
one or more cylinder blocks formed separately of the first and second portions and directly demountably coupled to the first or second portions, each cylinder block provided with a first surface facing the portion to which that block is coupled and an opposite second surface, and one or more cavities opening onto the second surface for receiving respective pistons.

In one embodiment, respective pairs of cylinder blocks are oppositely disposed in the housing with their respective second surfaces facing each other. Although in an alternate embodiment all of cylinder blocks are coupled to the first portion.

The cylinder blocks may be made in a variety of different sizes, with different sized cylinder blocks provided with a different number of cavities. Thus for example cylinder blocks could be made with say one, two and four cavities. This enables brakes with different numbers of brake pistons to be easily made by simply attaching the appropriate number of different sized blocks to the housing portions.

The housing can be provided with a circumferential seat for seating each cylinder block. The housing may also comprise a circumferential wall extending about one of the first and second portions.

In this embodiment the seat spaces each cylinder block from an inner circumferential surface of the circumferential wall to define a gap between each cylinder block and the inner circumferential surface.

The brake housing may further comprise a cooling manifold disposed in said gap.

The first portion of the brake housing may comprise a first plate and the circumferential wall which extends about the first plate. The first plate and circumferential wall may be integrally formed.

The second portion may comprise a second plate. The second portion may also comprise a first radial surface provided with one or more pad seats adapted for seating respective brake pads.

In the event that a cylinder block has two or more cavities the cylinder block can be provided with one or more galleries providing fluid communication between the two or more cavities.

In one variation of the housing each of the first and second portions may comprise a plate and a circumferential wall extending about the plate, the circumferential walls being axially aligned and axially adjacent, when the portions are coupled together to form a drum like structure defining the space.

According to a further aspect of the invention there is provided a brake housing comprising:
at least one cylinder block demountably coupled to an inside surface of the brake housing, each cylinder block provided with one or more cavities opening onto a surface of the cylinder block for receiving respective pistons; and,
a seat portion on the inside surface for seating each of the at least one cylinder block on the brake housing.

According to a further aspect of the present invention there is provided a disc brake comprising:
a housing in accordance with a first aspect of the present invention;
a rotor located in the housing;
a piston in each cavity of each cylinder block;
a first set of brake pads disposed between the pistons and a facing first radial face of the rotor; and,
a second set of brake pads retained in the housing and facing a second radial face of the rotor.

A method of constructing a brake housing comprises:
providing a plurality of separate housing portions that, when coupled together, define a space;
providing a separate cylinder block having one or more cavities opening onto one surface of the cylinder block; and,
demountably coupling the cylinder block onto one of the housing portions with the one surface facing away from the one housing portion.

### BRIEF DESCRIPTION OF THE DRAWINGS

An embodiment of the present invention will now be described by way of example only with reference to the accompanying drawings in which:

FIG. 1 is an exploded view of a brake assembly comprising an embodiment of the brake housing in accordance with the present invention;

FIG. 2 is a schematic representation of a portion of the brake housing and an associated cylinder block incorporated in an embodiment of the present invention;

FIG. 3 is a perspective view from the bottom of the cylinder block depicted in FIG. 2; and,

FIG. 4 is a plan view of a second portion of the brake housing.

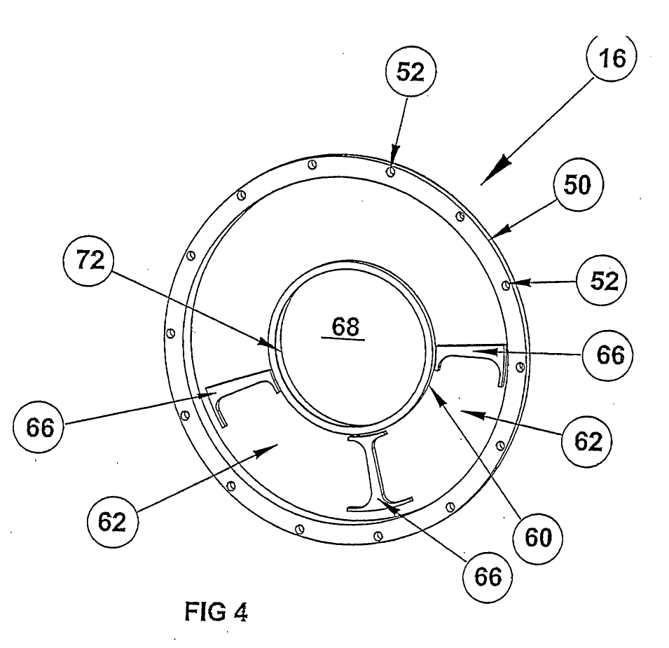

### DETAILED DESCRIPTION OF PREFERRED EMBODIMENT

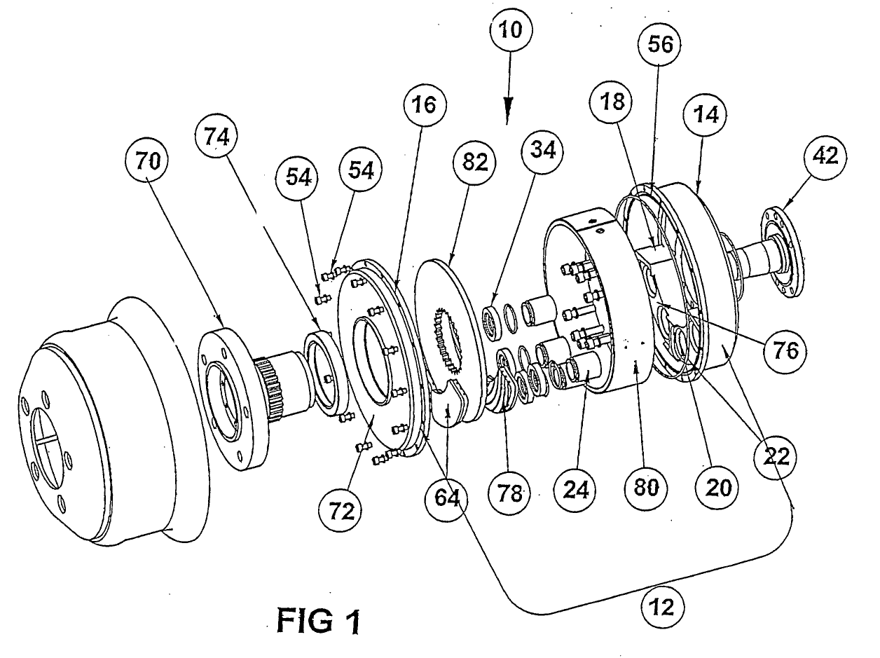

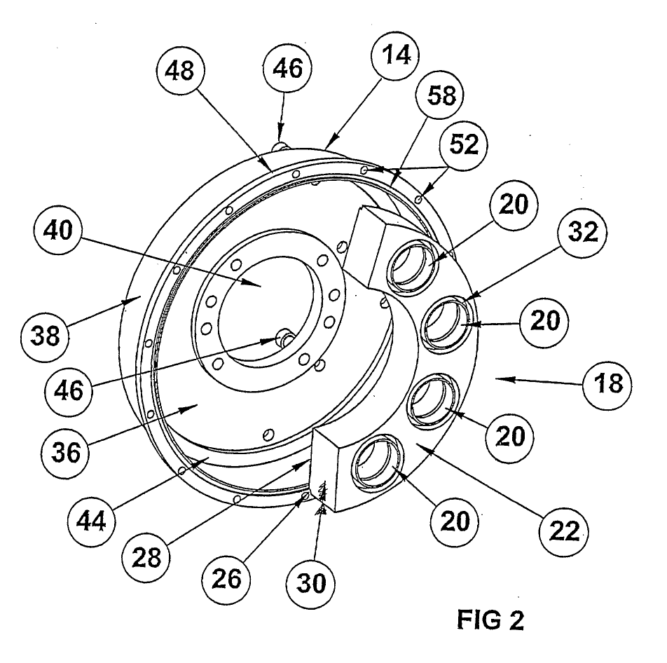

Referring to the accompanying drawings and in particular FIGS. 1 and 2, a brake assembly 10 is depicted incorporating a brake housing 12 made up of a first portion 14 and second portion 16, the housing 12 comprising a demountably coupled cylinder block 18. The cylinder block 18 is provided with one or more cavities 20 opening onto a surface 22 of the cylinder block 18 for receiving respective pistons 24.

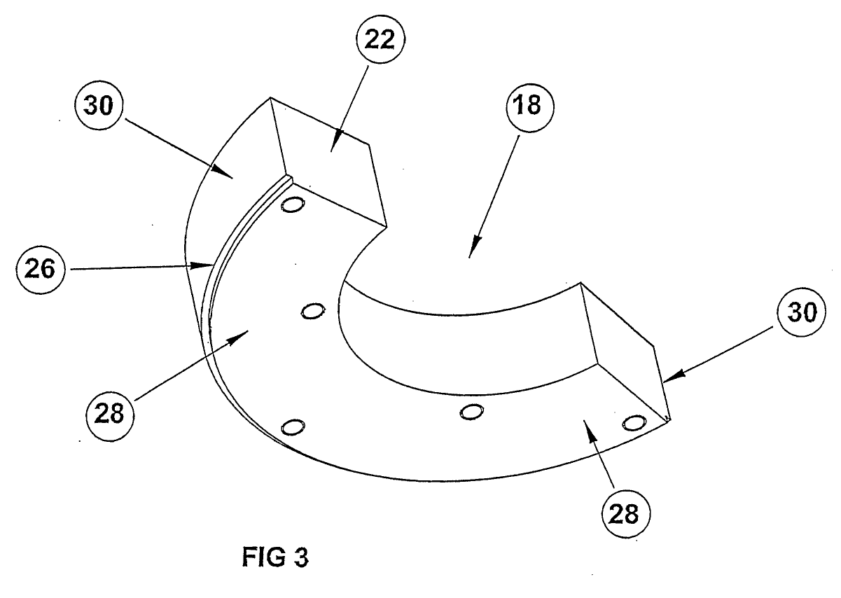

From FIGS. 2 and 3, it will be seen that the cylinder block 18 is formed separately of the portions 14 and 16 of the housing 12. In this embodiment the cylinder block 18 is in the configuration of a sector of an annular ring having substantially planar faces at each axial end. The cylinder block 18 is depicted as having four cavities 20 for receiving respective pistons 24. However any number of cavities 20 can be formed in the cylinder block 18. When the cylinder block 18 comprises more than one cavity 20, it may further include one or more internal galleries (not shown) providing fluid communication between the cavities 20. This enables hydraulic brake fluid pressure delivered to one of the cavities 20 to be communicated to the remaining cavities 20 of a particular cylinder block 18.

A shoulder or rebate 26 is formed on a surface 28 of the cylinder block 18 opposite the surface 22 and adjacent an outer circumferential surface 30 of the cylinder block. Inlet ports (not shown) can be provided on the surface 30 (or the surface 28) for coupling with a brake fluid circuit to provide fluid communications with the internal galleries of the block 18. To facilitate this connection holes are drilled at appropriate locations in the housing portions for hoses/pipes to pass through. Bleed or fluid return ports may also be provided on the, or the opposite, surface 30; or, surface 28 and subsequently connected to the brake fluid circuit. When the brake housing incorporates two or more blocks 18, the bleed or fluid return port of one block can be connected by a hose to the inlet port on another block. Alternatively each block 18 can be separately plumbed into the brake fluid circuit. This allows both series and parallel connection of the blocks 18 to the brake fluid circuit.

Surrounding each cavity 20 is an annular groove or recess 32 for receiving an outer skirt of a heat shield 34 (see FIG. 1) coupled to respective piston 24. The heat shield 34 can take the form of that described in Applicant's International publication No. WO 03/019033, the contents of which are incorporated herein by way of reference.

The first portion 14 of the housing 12 is of a configuration similar to a drum of drum brake system and comprises a first plate 36 and a circumferential wall 38, that may be integrally formed, extending about the plate 36. The plate 36 is provided with a central hole 40 which, in the brake assembly 10, receives a stub axle 42.

A circumferential seat 44 is formed about an inside of the housing, and more particularly on the circumferential wall 38 adjacent the plate 36. The cylinder block 18 is demountably coupled to the housing 12 by seating the shoulder 26 on the seat 44 with surface 28 of the block 18 bearing against an inside surface of the first plate 36. The cylinder block 18 is demountably coupled directly to the housing portion 14 by a number of screws or bolts 46 that are screwed in from an outside surface of the plate 36. Thus, the cylinder block 18 is fixed to and does not move relative to the housing 12, i.e. the housing portion 14 and the housing portion 16.

It will be appreciated that the position of the cylinder block 18 within the housing portion 14 is at the sole discretion of the person assembling the housing 12 and brake assembly 10. It is envisaged that at the time of manufacture neither the housing portion 14 nor the cylinder block 18 will be provided for holes for the screw or bolts 46. These holes would be drilled at the time of assembly in order to match the positional or locational requirements of the cylinder block 18. This allows a brake manufacturer or vehicle manufacturer to adapt the configuration of the brake to suit the vehicle at hand. The freedom provided is enhanced by the provision of a plurality of cylinder blocks 18 having different numbers of cavities 20. For example cylinder blocks 18 could be formed with one, two and four cavities 20 and simply mixed and matched at will to suit a particular application at hand.

The housing 12 is completed by the second portion 16 which is in the form of a plate that bolts onto an axial end of the first portion 14 opposite the plate 16. To assist in this coupling, the portions 14 and 16 are each provided with respective coupling flanges 48 and 50. The flanges 48 and 50 are provided with a plurality of holes 52 that are predrilled to ensure mutual registration when the portions 14 and 16 are brought together. The portions 14 and 16 are then coupled together by way of bolts 54. When the housing 12 is incorporated in a wet brake system, a circumferential seal 56 is provided that seats in a groove 58 formed in the first portion 14 adjacent and radially inside of the flange 48.

An inside radial face 60 of the second portion 16 is provided with one or more pad seats 62 for seating respective brake pads 64. The seats 62 are formed by lands or ridges 66 that can be either integral with, or separate from and attached to, the surface 60 of the first portion 16. The lands or ridges 66 are shaped to receive opposite lateral ends of the brake pads 64.

The portion 16 is also provided with a central hole 68 through which a splined hub 70 extends. A seat 72 circumscribes the hole 68 and receives a seal 74.

If desired, and indeed as illustrated in FIG. 1, the cylinder blocks 18 may also be provided with pad seats 76 for receiving brake pads 78. The seats 76 are formed on the surface 22 and overlie one or more cavities 20, and thus pistons 24.

By forming the seat 44 on the first portion 14 and shoulder 26 on the cylinder block 18, when the block 18 is demountably coupled to the portion 14, a gap is formed between the inside surface of the circumferential wall 38 and the outer circumferential surface 30 of the cylinder block 18. This gap is occupied by a cooling jacket or manifold 80 of a structure similar to that described in Applicant's International Publication No. WO 03/089303, the contents of which is incorporated herein by way of reference.

WO 03/089803 describes a fluid cooled brake housing comprising a drum-like casing having a circumferential wall provided with an internal fluid flow path and a fluid inlet and fluid outlet that communicate with the flow path. The manifold 80 can take the form of the circumferential wall of WO 03/089803. In essence, this can comprise two flat strips of metal that are overlaid, with one or both of the strips being provided with one or more grooves on the overlaid faces of the strips to form corresponding channels between the strips. The strips are rolled to form a ring and sealed together. An inlet and outlet are drilled or otherwise formed in the ring to communicate with opposite ends of the channels.

In the brake assembly 10 shown in FIG. 1 a rotor 82 is disposed within the housing 12 and is axially slidable on the splined portion of the hub 70. It will be seen that the brake pads 64 and 78 are axially aligned and disposed on opposite sides of the rotor 82. When a braking action is required, pressurised hydraulic fluid is delivered to the cylinder block 18. This in turn forces the brake pads 78 against the rotor 82. The rotor 82 is free to slide along the splines of the hub 70 and will do so until contacted on the opposite side by brake pads 64. At this time, the hydraulic brake pressure is effectively applied to the rotor 82 by the pads 64 and 78.

It will be apparent from the above description that embodiments of the present invention have a substantial benefit over the prior art due to the demountable nature of the cylinder block 18. By virtue of this, it is possible to separately manufacture the cylinder block 18 from the housing 12 and allow a brake or vehicle manufacturer to then attach one or more cylinder blocks 18 as required to the housing 12 to suit a particular application.

All modifications and variations that would be obvious to a person of ordinary skill in the art are deemed to be within the scope of the present invention the nature of which is to be determined from the above description and the following claims.

1. A brake housing comprising:
separate first and second portions, each portion having an opening through which a rotating body passes, the first and second portions coupled together to form a drum-like structure defining an internal space about a portion of the rotating body; and,
one or more cylinder blocks located inside the space and formed separately of the first and second portions and directly demountably coupled to one of the first and second portions, each cylinder block provided with a first surface facing the portion to which the block is coupled and an opposite second surface, and one or more cavities opening onto the second surface for receiving respective pistons.

2. The housing according to claim 1 further comprising a circumferential seat for seating each cylinder block.

3. The housing according to claim 2 further comprising a circumferential wall extending about one of the first and second portions.

4. The housing according to claim 3 wherein the seat spaces each cylinder block from an inner circumferential surface of the circumferential wall to define a gap between each cylinder block and the inner circumferential surface.

5. The housing according to claim 5 further comprising a cooling manifold disposed in said gap.

6. The housing according to claim 3 wherein the first portion comprises a first plate and the circumferential wall which extends about the first plate.

7. The housing according to claim 6 wherein the first plate and circumferential wall are integrally formed.

8. The housing according to claim 1 wherein when there is more than one cylinder block, respective pairs of cylinder blocks are oppositely disposed in the housing with their respective second surfaces facing each other.

9. The housing according to claim 1 wherein when there is more than one cylinder block, each cylinder block is coupled to the first portion.

10. The housing according to claim 1 wherein at least two of the cylinder blocks are provided with a different number of cavities.

11. The housing according to claim 1 wherein when a cylinder block has two or more cavities that cylinder block is provided with one or more galleries providing fluid communication between the two or more cavities.

12. The housing according to claim 1 wherein the second portion comprises a first radial surface provided with one or more pad seats adapted for seating respective brake pads.

13. The housing according to claim 1 wherein each of the first and second portions comprise a plate and a circumferential wall extending about the plate, the circumferential walls being axially aligned and axially adjacent when the portions are coupled together to form the drum like structure defining the space.

14. A brake housing comprising:
at least one cylinder block demountably coupled to an inside surface of the brake housing, each cylinder block provided with one or more cavities opening onto a surface of the cylinder block for receiving respective pistons; and,
a seat portion on the inside surface for seating each of the at least one cylinder block on the brake housing.

15. A disc brake comprising:
a housing in accordance with claim 1;
a rotor located in the housing;
a piston in each cavity of each cylinder block;
a first set of brake pads disposed between the pistons and a facing first radial face of the rotor; and,
a second set of brake pads retained in the housing and facing a second radial face of the rotor.

16. A method of constructing a brake housing comprises:
providing a plurality of separate housing portions that, when coupled together form a drum-like structure and define an internal space therebetween;
providing one or more separate cylinder blocks each having one or more cavities opening onto one surface of the cylinder block; and,
demountably coupling the cylinder blocks onto one of the housing portions inside of the space with the one surface facing away from the one housing portion.
